(19) United States
(12) Patent Application Publication
(10) Pub. No.: US 2015/0068467 A1
(43) Pub. Date: Mar. 12, 2015

(54) Ball and Chain Link Pet Toy

(71) Applicant: John George Chirico, Daly City, CA (US)

(72) Inventor: John George Chirico, Daly City, CA (US)

(21) Appl. No.: 14/021,582

(22) Filed: Sep. 9, 2013

(51) Int. Cl. A01K 15/02

(52) U.S. Cl. CPC A01K 15/025
USPC 119/707

(57) ABSTRACT

A pet exercise and amusement device is provided that attaches a pet toy to a pet collar. The device includes a chain link assembly, a ball, and a clamping means for attaching the chain link assembly and ball to a pet collar. In a preferred embodiment, a hollow ball with a through hole is provided that accepts the chain link assembly therethrough. The chain link assembly includes a plurality of links with a clamp on one end and a ball retention element along the opposing end. Another contemplated embodiment includes a solid ball and an attachment loop adapted to provide connection to the chain link assembly. The device attaches to a pet collar for continuous exercise or amusement, and for preventing the pet from losing the toy while engaged therewith. The device can also be rapidly configured into different toys based on pet owner or pet needs.

### BACKGROUND OF THE INVENTION

1. Field of the Invention

The present invention relates to a pet exercise and amusement device, and particularly to a device for improving a ball and chain pet toy. The device includes a chain link having a clamping means on each side, which is threaded through a cylindrical bore within a pet ball or attached to an attachment loop on a solid pet ball. This invention will be appreciated by those who wish to handle and transport their pet toys in a quick and clean manner, while being able to adjust the device for different sized dogs. The invention is also useful for comforting pets with physical or psychological problems.

It is very important for pets, especially dogs, to receive constant exercise in order for them to maintain their health. It is also important for pets suffering from physical problems (e.g. arthritis) or psychological problems (e.g. separation anxiety) to have a toy that helps and does not hinder their well-being. Unfortunately, many pet owners do not have the time or the proper equipment to meet the daily needs of their pets.

Ball toys are usually a dog's favorite play toy, both as a chew toy and for retrieving during owner interaction. These items quickly become dirty and saliva-soaked with use. As a result, pet owners require ball toys with convenient structures like straps or handles to allow them to be transported or tossed without having to handle a sordid and saliva-soaked ball. However, some dogs like to play with standalone balls with no attached structures as they can become tangled around their legs and ultimately, frustrating to play with.

A solution to these problems is to provide a ball and chain device that can be used as a pet toy with a means to transport their pet toys in a quick and clean manner, adjust the device for different sized dogs, and comfort their dogs with physical or psychological problems. Specifically, the present invention comprises a ball that is adapted to receive or otherwise attach to a length of chain link. One side of the chain link includes a removable clamp that is used to attach to a dogs collar. The other end of the chain link has a ball retention element utilized to retain the ball during play or when attached to the pet's collar. Different ball retention elements are contemplated for different applications, including a chewable knot, a removable clamp, or another form of retention member that can support the ball when disposed at the end of the chain link assembly.

2. Description of the Prior Art

Devices have been disclosed in the prior art that relate to pet exercise and amusement devices. These include devices that have been patented and published in patent application publications. These devices generally relate to ball toys with rope handles or straps connected within or around the balls. The following is a list of prior art deemed most relevant to the present disclosure that are described for the purposes of highlighting and differentiating the unique aspects of the present invention and further highlighting the drawbacks existing in the prior art.

In the pet ball and chain devices of the prior art, none are provided that attach to the dog's collar, adjust for different sized dogs, or detach from the ball retention element such that the dog may play with a standalone ball.

One such device in the prior art is U.S. Pat. No. 7,543,550 to Simpson, which describes a pet toy and exercise device that allows the pet to exercise without the aid of the pet owner. The device has three sets of cords and a ball that can be hung from a support structure such as a ceiling or a tree limb. One elastic cord is connected to the support structure on one side and a non-elastic cord on the other. The non-elastic cord is then connected to the ball, while a second, shorter non-elastic cord is connected to the other side of the ball and is used for chewing or a grasping aid. While the device provides a useful unassisted exercise device for pets, it is not readily adjustable and pet owners would have to purchase specific cord lengths based on their pet's size.

Another such device is U.S. Pat. No. 5,961,406 to Hass, which describes a pet toy device with a ball having a looped handle. The ball has a hollow cavity with two openings where two ends of the handle are inserted into the openings and joined. The device improves the durability of pet ball toys by having the joining means of the handle inside the hollow cavity to prevent premature wear and breakage of the ball-handle mating areas. The device provides a ball and handle pet toy that can be transported by the pet owner without having to handle the used ball, however, the device cannot be connected to the dog's collar and the handle cannot be readily removed to enable the pet to play with a handle-less ball.

U.S. Pat. No. 4,321,888 to Topliffe describes a tethered ball device to be used as a toy for small dogs. The ball has two halves that feature multiple cylindrical passageways modeled on each side. When the two halves are adhered together they form a watertight seal and the cylindrical passageways form channels to receive cotton cable cord tethers. The tethered ball can then be used as a lightweight, graspable and pullable toy for one or more small dogs. While providing a useful amusement toy for small dogs, the device cannot be adjusted for different sized dogs and cannot be transported without the pet owner handling a filthy and saliva covered pet toy.

Finally, U.S. Patent Application Publication 2007/0062461 to Lubeck describes a device with a rope attached to a bounceable biting object in multiple configurations to be used as a dog toy. The biting object is a ball with equivalent material and performance characteristics as a tennis ball and has a hollow interior cavity with an opening on one side of the ball. A rope is attached to the ball by a method of creating a double knot within the hollow cavity. This device suffers from similar aforementioned adjustability and transportability problems.

None of the prior art provide the benefits inherent described by the present invention, nor do they suggest like or similar elements that would achieve the same goals. The prior art consists of overly complex, difficult to manufacture, and expensive designs with specialized components. Therefore, there is a need for a novel and useful pet toy device that is adaptable from a ball and chain toy to a standalone ball, attachable to a dog collar and adjustable for different sized dogs. In this regard, the instant invention substantially fulfills these needs.

The present invention is contemplated as an ideal tool for redirecting a pet's attention while suffering from physical and mental distress, including physical injuries and mental health issues such as found in elderly pets, those with obsessive compulsive disorders, and the like. It is submitted that the present invention is substantially divergent in design elements from the prior art, and consequently it is clear that there is a need in the art for an improvement to existing pet ball and chain toy devices. In this regard the instant invention substantially fulfills these needs.

### SUMMARY OF THE INVENTION

In view of the foregoing disadvantages inherent in the known types of pet amusement devices now present in the prior art, the present invention provides a new ball and chain link pet toy device that can be utilized to connect a pet ball toy to a pet's collar and adjust for different sized dogs, providing enhanced well-being and convenience for the pet and pet owner.

It is therefore an object of the present invention to provide a new and improved pet amusement device that has all of the advantages of the prior art and none of the disadvantages.

It is another object of the present invention to provide a ball and chain link device that is readily attachable to a typical dog collar.

Another object of the present invention is to provide a hollow ball toy with a through hole for a chain link to be threaded through.

Another object of the present invention is to provide a solid ball toy with having an attachment loop adapted to secure to the chain link, which can then be attached to a pet's collar.

Yet another object of the present invention is to provide a pet amusement device that attaches to a ball toy with a ball retention element therealong for securing to the chain link, which can then be attached to a pet's collar.

A final object of the present invention is to provide a pet toy that is adjustable for different sized pets and can be utilized for amusement and comforting purposes.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the preferred embodiment of the present invention in an assembled state such that the pet owner can initiate play with their pet or actuate the clamp and attach the chain link to a pet collar.

FIG. 2 shows a view of an alternate embodiment of the present invention, attached to a pet's collar in an adjusted state.

FIG. 3 shows a perspective view of an alternate embodiment of the present invention, wherein an attachment loop is shown extending therefrom and attaching to a chain link.

FIG. 4 shows a perspective view of the present invention, in a disassembled state with the standalone ball toy.

FIG. 5 shows a view of another embodiment of the ball retention element, where a ball end stop is provided.

### DETAILED DESCRIPTION OF THE INVENTION

Reference is made herein to the attached drawings. Like reference numerals are used throughout the drawings to depict like or similar elements of the dumbbell attachment device. For the purposes of presenting a brief and clear description of the present invention, the preferred embodiment will be discussed as provided for amusing and soothing a pet using a ball and chain device. The figures are intended for representative purposes only and should not be considered to be limiting in any respect.

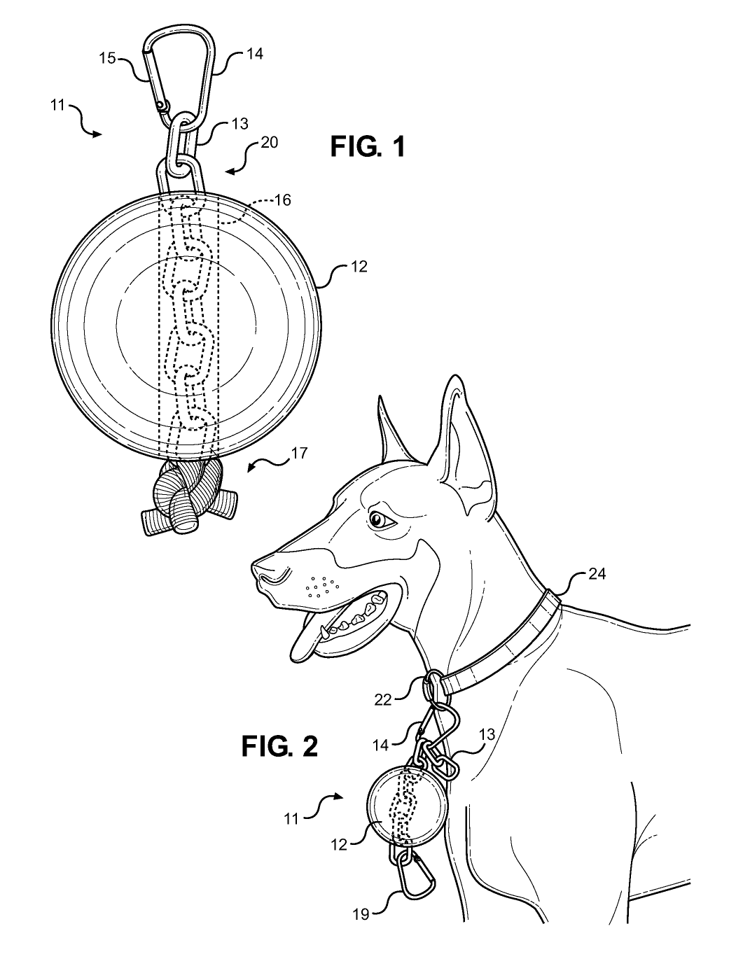

Referring now to FIG. 1, there is shown a view of an embodiment of the ball and chain device 11 of the present invention in an assembled state. The device comprises a hollow ball 12 that is secured by a chain link assembly 20 fed therethrough. The hollow ball 12 comprises a through hole 16 that is located through the ball's central axis in order to receive the chain link assembly 20. The ball 12 is preferably made of a durable rubber material that is typically used on dog toys. The chain link assembly 20 has a plurality of chain links 13 that are attached to a removable clamp 14 on one end and a ball retention element at the opposite end. In one embodiment, the ball retention element is a rope knot 17 that can be chewed on by the dog or used in tug of war play exercises.

The removable clamp 14 and the ball retention element are used to retain the hollow ball 12 between both ends of the chain link assembly 20. The removable clamp 14 is preferably a spring-loaded latching mechanism 15 that enables the pet owner to use the device in several ways. In the assembled state, the pet owner can actuate the clamp's latching mechanism 15 and attach the device to a pet's collar, or begin playing fetch or tug-of-war with the dog, or remove the clamp 14 and withdraw the chain link from the ball 12. By removing the clamp 14, the pet owner and dog can use the hollow ball 12 by itself as the primary play toy.

The removable clamp 14 is preferably a typical carabineer with a metal loop and a spring-loaded gate. It should be appreciated that many types of materials and clamping means can be utilized to provide the ability to quickly and easily clamp the device to a dogs collar and be readily removable to disassemble the device.

The chain links 13 are torus-shaped to provide flexibility and adjustability of the device. The open interior portion of the torus-shaped links allows the clamp 14 to be positioned at multiple points in the chain link 13 to adjust the device to different lengths based on pet owner preferences or different sized dogs. The chain links 13 are made out of a metallic material, hard plastic, or some other durable but lightweight composite to provide strength while being lightweight enough to not injure or overburden the dog with additional weight around their neck. Alternatives to the chain material include rubber, plastic, or composite material for reduced weight.

The rope knot 17 embodiment of the ball retention element is used for chewing or gripping by the dog. The knot 17 is made of durable nylon rope and is permanently adhered to the chain link 13 by tying the knot around the end of the chain link 13 and applying non-toxic adhesive to the knot 17 and chain link 13. It should be appreciated that the nylon rope can be any durable material that prevents premature wear caused by the teeth of a pet and everyday use. Another alternative for a ball retention element may include an oversized link attached at the end of the chain, the link being composed of the same chain link material and of such a size that it does not fit or pass through the smaller diameter of the hole passage in the ball itself.

Referring now to FIG. 2, there is shown a view of the ball and chain device 11 according to a second embodiment. Similar to the embodiment illustrated in FIG. 1, this embodiment includes a hollow ball 12 and removable clamp 14, but instead of a non-removable knot 17 as the ball retention element, this embodiment contemplates a removable clamp 19 attached to the end of the chain link assembly and below the ball 12. The addition of another removable clamp 19 allows for further adjustability of the device and rapid removal of the hollow ball 12 while the device is attached to the dog's collar.

Furthermore, FIG. 2 shows the device in an adjusted state and attached to the dog's collar 24. In order to adjust the device the pet owner removes the clamp 14 from the end of the chain link 13 and attaches it to the appropriate link at the desired length and then attaches the clamp 14 to the O-ring 22 on the dog's collar 24. When properly attached to the dog's collar 24, the dog can play with the device without the support of the pet owner. This is particularly useful for pets that require constant stimulation, have trouble locating their toys, or have other physical, mental, or physiological issues. In addition, when in the attached state the likelihood of the pet owner or pet misplacing the ball will be eliminated. It should be appreciated that the embodiment of FIG. 1 can be utilized in similar fashion as described here.

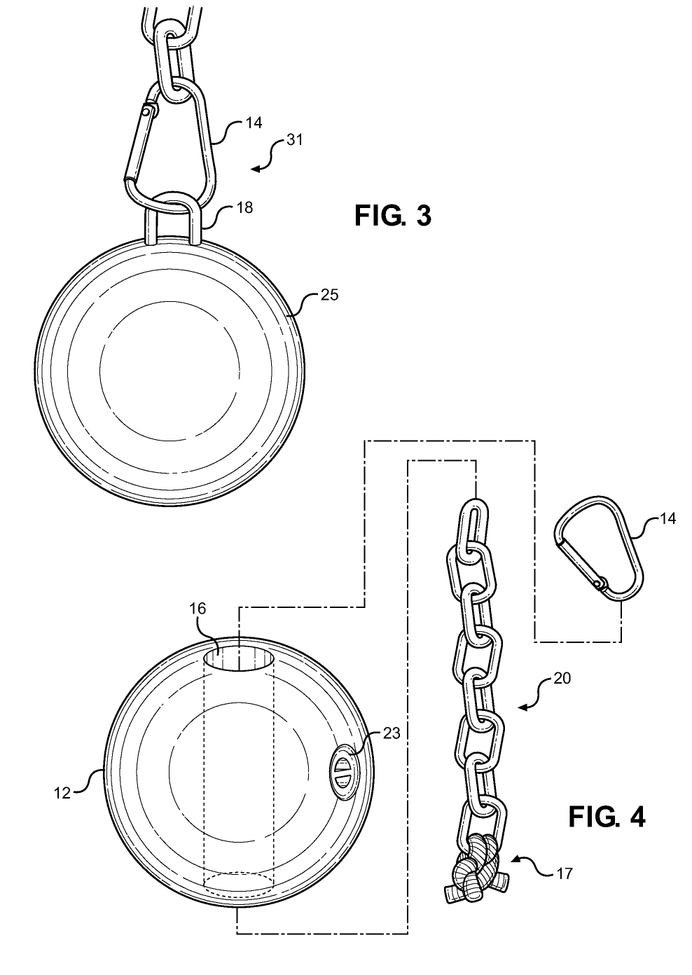

Referring now to FIG. 3, there is shown a perspective view of the ball and chain device according to yet another embodiment 31. In this embodiment 31, there is a solid ball 25 with a U-shaped attachment loop 18 protruding therefrom. The clamp 14 can be attached to the attachment loop 18 and used as described in the above embodiments. Alternatively, a solid chain link can be received by the attachment loop 18 for a permanent connection therebetween, whereby the final chain link of the chain link assembly is secured by the attachment loop. The solid ball 25 and attachment loop 18 embodiment provides a configuration that may be preferred over the hollow ball based on pet owner and pet desires. This embodiment 31 also provides a more suitable standalone ball toy as the pet owner will have a handle to pick up and launch the ball during play and transportation, while also reducing or eliminating the pet owner from handling a saliva-ridden and dirty pet toy.

Referring now to FIG. 4, there is shown a perspective view of the ball and chain device in a disassembled state. In this state, the pet owner and pet have multiple options of play. The pet can play with or chew the chain link assembly 20 or with the hollow ball 12. Further shown in FIG. 4 is the addition of a standard squeaker 23 mechanism, which can be inserted into the hollow ball 12 or flush mounted on the ball's surface. The squeaker creates a sound when the pet compresses the ball, as is well understood in the art of pet and dog toys.

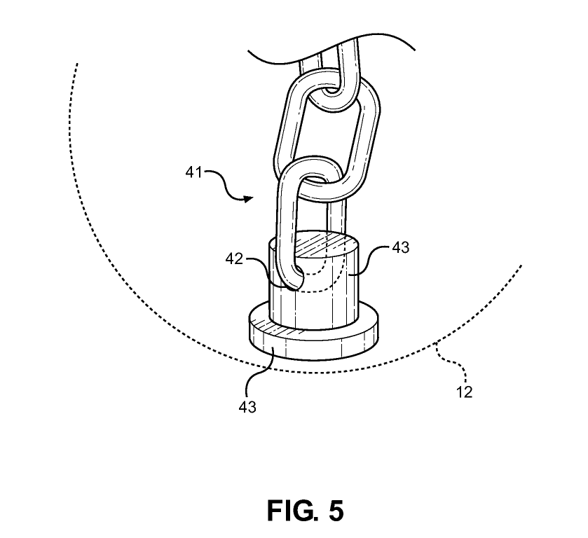

Referring finally to FIG. 5, there is shown yet another embodiment of the ball retention element of the present invention. In this embodiment, the final chain link within the hollow ball 12 is attached to a ball-stop element 41 that includes a raised ridge 43 that is of greater diameter than the through hole in the hollow ball 12. An upstanding portion 43 of the ball-stop element is inserted into the through hole while the ridge 43 prevents the ball from sliding off of the end of the chain. A hole 42 in the upstanding portion 43 accepts a link in the chain to secure the two elements together while in use. This embodiment retains the ball 12 at the end of the chain, wherefrom the ball 12 can be removed by detaching the upper clamp from the opposite end of the chain link assembly.

Overall, the present invention provides a unique configuration for the ball and chain pet toy, which allows the pet owner and pet to be extremely flexible and adaptable while playing, while also providing an affordable and safe toy. The toy is adapted to entertain a pet and provide comfort thereto. The device is attachable to a pet collar and can be readily detached and used in different ways. The several embodiments provide for alternatives for the pet owner, wherein a chain link assembly attachable to a pet collar and supporting a pet chew toy is desired.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A ball and chain pet toy and exercise device, comprising:
a chain link assembly comprising a plurality of interlocked chain links;
a pet ball toy having a through hole adapted to receive said chain link assembly therethrough;
said chain link assembly having a removable clamp on one end and a ball toy retention element on an opposing end;
said removable clamp having latching means adapted to be operably released from said chain link assembly or to said chain link assembly to a pet's collar.

2. The ball and chain pet toy of claim 1, wherein said through hole is located through the central axis of said pet ball toy.

3. The ball and chain pet toy of claim 1, wherein said ball is comprised of a rubber material.

4. The ball and chain pet toy of claim 1, wherein said removable clamp latching means comprises a spring loaded latching mechanism to open and close said removable clamp.

5. The ball and chain pet toy of claim 1, wherein said ball toy retention element is a rope knot.

6. The ball and chain pet toy of claim 1, wherein said ball toy retention element is a second removable clamp.

7. The ball and chain pet toy of claim 1, wherein said ball toy retention element is a ball-stop element having a raised ridge of greater diameter than said through hole in said pet ball toy.

8. A ball and chain pet toy and exercise device, comprising:
a chain link assembly comprising a plurality of interlocked chain links;
a pet ball toy having an attachment loop extending therefrom;
said chain link assembly having a removable clamp on one end and a ball toy retention element on an opposing end;
said removable clamp having latching means adapted to be operably released from said chain link assembly or to said chain link assembly to a pet's collar.

9. The ball and chain pet toy of claim 8, wherein said ball is comprised of a rubber material.

10. The ball and chain pet toy of claim 8, wherein said removable clamp latching means comprises a spring loaded latching mechanism to open and close said removable clamp.

11. The ball and chain pet toy of claim 8, wherein said ball toy retention element is a second removable clamp adapted to attach to said attachment loop.

12. The ball and chain pet toy of claim 8, wherein said ball toy retention element is a chain link secured by said attachment loop.
